(19) United States
(12) Patent Application Publication
(10) Pub. No.: US 2008/0039065 A1
(43) Pub. Date: Feb. 14, 2008

(54) Data transmission in a communication session

(75) Inventors: Andreas Schmidt, Braunschweig (DE); Holger Schmidt, Braunschweig (DE); Norbert Schwagmann, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Munich (DE)

(21) Appl. No.: 11/470,493

(22) Filed: Sep. 6, 2006

(30) Foreign Application Priority Data
Sep. 9, 2005 (DE) 102005043006.6-31

(51) Int. Cl. H04Q 7/20

(52) U.S. Cl. 455/422.1

(57) ABSTRACT

The data are transmitted, within a communication session, where the participating communication terminals are registered in different communication networks, with the use of a data distribution unit additionally provided in a communication network in which the controlling server unit is not provided, such that between the communication networks only a data distribution starting from the controlling server unit to the data distribution unit occurs, which, for its part, forwards the data to the mobile radio communication terminals located in the respective communication network.

### TECHNICAL FIELD

The invention relates to a communication system, a communication session server unit and a data distribution unit, as well as methods for transmitting data within a communication session.

### BACKGROUND OF THE INVENTION

When the participants of a communication system belong to different communication networks this means that typically the same data are transmitted from a server unit in one communication network to each participant and his communication terminal, respectively, in the other communication network. The multiple transmission of the data (media) from the one communication network into the other communication network often causes a very high data load between the communication networks und leads to high costs.

### SHORT DESCRIPTION OF THE FIGURES

In the figures:

FIG. 1 shows a conventional push-to-talk over cellular communication system;

FIG. 2 shows a simplified representation of the conventional push-to-talk over cellular communication system represented in FIG. 1;

FIG. 3 shows a push-to-talk over cellular communication system, in accordance with an embodiment of the invention;

FIG. 4 shows a sketch of a push-to-talk over cellular communication system, in accordance with an embodiment of the invention, wherein the distribution of media data is shown;

FIG. 5 shows a sketch of a push-to-talk over cellular communication system, in accordance with another embodiment of the invention, wherein an alternative distribution of media data is shown, compared with the illustration in FIG. 4.

### DETAILED DESCRIPTION

By means of a conference communication system, it is made possible to communicate between several users with the assistance of communication terminals.

In order to enable an orderly communication, usually not all participants of a conference and/or a communication session get the right to communicate over a pre-determined medium, such as for example audio, video, etc., at the same time. The right to communicate is also designated as a communication right in the following. The communication right is usually assigned according to specified rules. The communication right allocation is also frequently designated as “Floor Control” and the rules which are followed within the communication right allocation are also frequently designated as “Floor Policy”.

It is, for example, often usual in large conference rooms to employ a conference system with which several microphones and loudspeakers for speech communication are made available to the participants. The microphones must be switched on by the respective speaker for use. A switched-on microphone blocks all other microphones, so that only one speaker can be active at any time, or to put it another way, has the speech right. In exceptional cases a further microphone, for example the microphone of the conference leader, can be simultaneously active. The speech right is therefore usually assigned to only one participant and, where appropriate, to one or to several further participants, for example the conference leader.

In the area of mobile communication, comparable communication services are known for the provision of a conference between several communication terminals, for example in this area so-called half-duplex conference systems are known, for example a so-called Push-To-Talk (PTT) communication service, for example the communication service “Direct Connect” from the company Nextel or the communication service Push-to-talk Over Cellular (PoC) of the Standardization Committee Open Mobile Alliance (OMA). As in the case of a walkie-talkie, the speaker has in this case usually to press a special key on his mobile communication terminal in order to be able to send messages. The transfer of messages from other users is disabled during this time.

Furthermore, another conference system of the standardization committee IETF (Internet Engineering Task Force) is known, according to which communication rights are controlled by means of a special communication protocol, for example, the Binary Floor Control Protocol (BFCP).

In present push-to-talk conference systems, communication rights are frequently controlled by means of the so-called Real-time Transport Control Protocol (RTCP), i.e. by means of this protocol, communication rights are requested and assigned. Alternatively, the communication rights can also be controlled in some of these conference systems by means of the BFCP.

Conference systems in accordance with the IETF and push-to-talk systems usually have a centralized architecture.

This means that the participants in a conference provided by such a conference system do not communicate with each other directly, but by means of a central server unit. In the case of a mobile conference system, the central server unit is usually located in the non-mobile part of the communication network.

Furthermore, it is known that in current PTT conference systems, the central server unit usually includes a controlling function and in general participating functions communicating with the controlling function. One participating function is assigned to each participant, i.e. to each participant communication terminal, also designated as participating server unit for example.

The controlling function, for example implemented in a controlling server unit, includes functionalities which are assigned to the respective PTT communication session.

A participating function includes functionalities which are assigned to the participant corresponding to the participating function and/or to his participant communication terminal. A participating function is thus in fact a part of the corresponding participant communication terminal, wherein this part is located in the non-mobile communication network. All participating functions are usually linked with the controlling function of the communication session on the one hand and, on the other hand, with the participant respectively assigned to them or with his participant communication terminal, respectively.

If a PTT communication session has participants from different communication networks, the communication of the participants and their participant communication terminals, respectively, is implemented with several PTT server units. In this case, however, there is only exactly one central PTT server unit, over which the entire communication, and thus all data exchanged within the communication session and the communication conference run. This server unit includes the controlling function and, if necessary, participating functions if there are participants of the communication session in the communication network of the central PTT server unit. All other server units include only participating functions; in other words they are configured only as a participating server unit for the participants and/or their communication terminals of the respective communication network of the server unit.

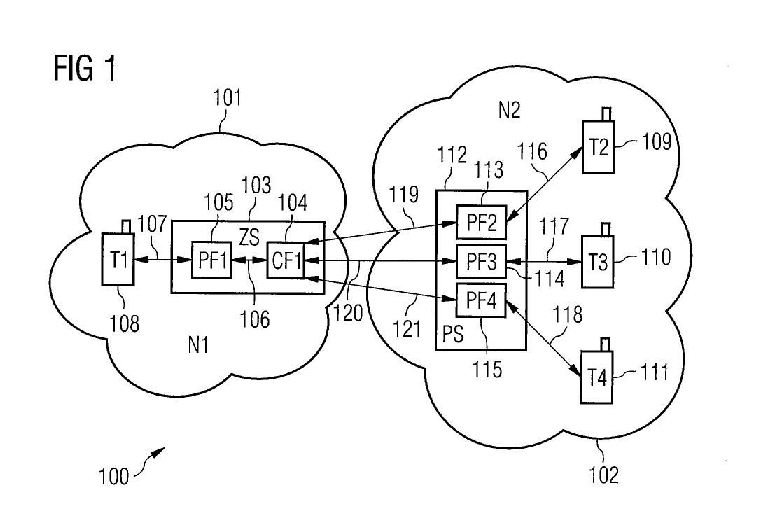

FIG. 1 shows as an example the architecture of a push-to-talk over cellular communication system 100, in accordance with the OMA communication standard. In FIG. 1 there are represented a first communication network operated by a first network operator 101, as well as a second communication network 102, which is operated by a second network operator.

The first communication network 101 has a first push-to-talk over cellular server unit 103 which, for its part, comprises a push-to-talk over cellular controlling server unit 104, as well as a push-to-talk over cellular participating server unit 105, which are connected with each other by means of a bi-directional interface 106. The PoC participating server unit 105 is connected with a first mobile radio communication terminal 108 of a first participant T1 by means of a radio communication connection 107 (bi-directional).

It is further shown in FIG. 1 that three participant communication terminals 109, 110, 111 are registered in the second communication network 102, namely a second mobile radio communication terminal 109 of a second participant T2, a third mobile radio communication terminal 110 of a third participant T3, as well as a fourth mobile radio communication terminal 111 of a fourth participant T4. Furthermore, a second push-to-talk server unit 112, which comprises three push-to-talk over cellular participating server units (PoC participating server units) 113, 114, 115, is provided in the second communication network 102, namely a second PoC participating server unit 113, which is assigned to the second mobile radio communication terminal 109, a third PoC participating server unit 114, which is assigned to the third mobile radio communication terminal 110, as well as a fourth PoC participating server unit 115, which is assigned to the fourth mobile radio communication terminal 111.

Every PoC participating server unit 113, 114, 115 is connected with the mobile communication terminal 109, 110, 111 assigned to it in each case by means of a corresponding mobile radio communication connection 116, 117, 118.

Furthermore, every PoC participating server unit 113, 114, 115, in the second communication network 102 is connected with the PoC controlling server unit 104 by means of a respective communication interface 119, 120, 121, and a respective corresponding communication connection. Thus a participant and a participant communication terminal, respectively, from a communication network without central push-to-talk controlling server unit 104 communicates within a push-to-talk cellular communication session using a push-to-talk over cellular participating server unit 113, 114, 115, of the own communication network in each case, in this case the second mobile radio communication terminal 109, the third mobile radio communication terminal 110 and the fourth mobile radio communication terminal 111 with the central push-to-talk over cellular controlling server unit of the foreign network, i.e. the other communication network, in this case with the PoC controlling server unit 104 of the first communication network 101. Thus in conference systems and push-to-talk systems the data (media) is usually not exchanged directly between the participants and their communication terminals, respectively, but via a central server unit.

If the participants of a conference or PTT communication session are associated with different communication networks, this means that the same data will usually be transmitted from the controlling server unit in one communication network to every participant an his communication terminal, respectively, in the other communication network. The multiple transmission of the data (media) from one communication network into the other communication network often causes very high quantities of data between the communication networks and leads to high costs.

According to one embodiment of the invention within a communication session with several communication terminals which are located in different communication networks, the amount of data to be transmitted between the different communication networks is reduced.

According to one embodiment of the invention a communication system is provided that comprises a first communication network, as well as a second communication network. The first communication network comprises a central communication session server unit for the provision of a communication session between a plurality of communication terminals. Furthermore, the communication system comprises at least one first communication terminal, which is registered in the first communication network. The second communication network comprises a data distribution unit, also designated as a media data distribution unit in the following, for distributing data to communication terminals in the second communication network. Furthermore, the communication system comprises at least one second communication terminal, which is registered in the second communication network. The central communication session server unit is configured in such a way, that, during setup of a communication session, it establishes, by means of the data distribution unit of the second communication network, a communication connection between the at least one first communication terminal and the at least one second communication terminal, and that it sends the data to be transmitted to the at least one second communication terminal within the communication session at least partially to the data distribution unit, or that it at least partially receives the data to be transmitted to the at least one first communication terminal within the communication session from the data distribution unit and forwards this data to the at least one first communication terminal. The data distribution unit of the second communication network is configured in such a way, that it receives the data to be transmitted to the at least one second communication terminal within the communication session and forwards this data to the second communication terminal, or that it receives the data to be transmitted to the at least one first communication terminal within the communication session and forwards this data to the central communication session server unit.

According to a further embodiment of the invention a communication session server unit in a first communication network for the provision of a communication session between a plurality of communication terminals is provided which, during setup of a communication session between at least one first communication terminal registered within the first communication network and at least one second communication terminal registered within a second communication network, establishes a communication connection by means of a data distribution unit arranged within the second communication network, and sends data to be transmitted to the at least one second communication terminal within the communication session at least partially to the data distribution unit, or at least partially receives data to be transmitted to the at least one first communication terminal within the communication session from the data distribution unit and forwards this data to the at least one first communication terminal.

According to a further embodiment of the invention a data distribution unit in a second communication network for the distribution of data to communication terminals is provided that, within a communication session, provided by a central communication session server unit located in a first communication network, between at least one first communication terminal registered in the first communication network and at least one second communication terminal registered in the second communication network, at least partially receives, by means of a communication connection established between the data distribution unit and the central communication session server unit, data to be transmitted to the at least one second communication terminal within the communication session, and forwards this data to the at least one second communication terminal, and/or that, within a communication session, provided by a central communication session server unit located in a first communication network, between at least one first communication terminal registered in the first communication network and at least one second communication terminal registered in the second communication network, at least partially receives, by means of a communication connection established between the data distribution unit and the central communication session server unit, data to be transmitted to the at least one first communication terminal, and forwards this data to the central communication session server unit.

According to a further embodiment of the invention a method for transmitting data within a communication session between at least one first communication terminal registered in a first communication network and at least one second communication terminal registered in a second communication network is provided, wherein the data are at least partially transmitted from a central communication session server unit located in the first communication network for the provision of a communication session between a plurality of communication terminals to a data distribution unit located in the second communication network for distributing data to communication terminals of the second communication network, and/or from the data distribution unit to the central communication session server unit. Furthermore, the data are forwarded from the data distribution unit to the second communication terminal and/or the data are forwarded from the central communication session server unit to the at least one first communication terminal.

In a method for transmitting data, within a communication session between at least one first communication terminal registered in a first communication network and at least one second communication terminal registered in a second communication network, in accordance with another embodiment of the invention, the data sent from a data distribution unit, located in the second communication network, for distributing data to communication terminals of the second communication network, are received at least partially by a central communication session server unit, located in the first communication network, for the provision of a communication session between a plurality of communication terminals, and the received data are forwarded from the central communication session server unit to the first communication terminal.

In accordance with another embodiment of the invention, a method is provided for transmitting data, within a communication session between at least one first communication terminal registered in a first communication network and at least one second communication terminal registered in a second communication network, wherein the data sent from the at least one first communication terminal are received at least partially by a central communication session server unit, located in the first communication network, for the provision of a communication session between a plurality of communication terminals, and wherein the received data are forwarded from the communication session server unit to a data distribution unit, located in the second communication network, for the distribution of data to communication terminals of the second communication network.

In accordance with another embodiment of the invention a method is provided for transmitting data, within a communication session between at least one first communication terminal registered in a first communication network and at least one second communication terminal registered in a second communication network, wherein the data sent from a central communication session server unit located in the first communication network, for the provision of a communication session between a plurality of communication terminals, are received at least partially by a data distribution unit located in the second communication network, for the distribution of data to communication terminals of the second communication network, and wherein the received data are forwarded by the data distribution unit to the at least one second communication terminal.

In accordance with another embodiment of the invention, a method is provided for transmitting data, within a communication session between at least one first communication terminal registered in a first communication network and at least one second communication terminal registered in a second communication network, wherein the data sent from the at least one second communication terminal are received at least partially by a data distribution unit located in the second communication network, for the distribution of data to communication terminals of the second communication network, and wherein the received data are forwarded by the data distribution unit to a central communication session server unit located in the first communication network, for the provision of a communication session between a plurality of communication terminals.

According to one embodiment of the invention that it is not the case that a central communication session server unit in a first communication network transmits the data to the respective participating server units in a second communication network and over that to the respective communication terminal in the second communication network, but that a data distribution unit is provided in the second communication network, over which the data are transmitted to or from, respectively, the second communication terminals in the second communication network. The transmission between the units of different communication networks is effected by means of only one communication connection, namely by means of a communication connection between the central communication session server unit, for example a communication session controlling server unit, and a data distribution unit additionally provided in the second communication network, which, for its part, communicates with the communication terminals directly or indirectly via further server units provided in the second communication network, for example, push-to-talk participating server units.

In this way, according to one aspect of the invention, a considerable reduction of the inter-communication network data transfer is achieved within an inter communication network communication session, wherein, in the case of n communication terminals in the second communication network, which participate in a communication session generated by a communication terminal in the first communication network, wherein the communication session is controlled by a central communication session server unit in the first communication network, a reduction of the amount of data to be transmitted by a factor of

$$\frac{1}{n}$$

is achieved.

Exemplary embodiments of the invention result from the dependent claims. It has to be pointed out that the embodiments of the invention described below apply correspondingly, as far as appropriate, in a similar or analogous manner to the communication system, to the communication session server unit and to the data distribution unit, as well as o the methods for transmitting data in a communication session.

It has to be pointed out that, in principle, an arbitrary number of first communication terminals located in the first communication network, can be provided, as well as an arbitrary number of communication terminals located in the second communication network. Furthermore it has to be pointed out that the communication system can be provided with an arbitrary number of further communication networks and further communication terminals registered therein, which participate in the communication session. Correspondingly, an own data distribution unit is provided for each further communication network, for the distribution of data to communication terminals which are registered in the respective communication network.

Embodiments of the invention can be realized, at least in part, in software, i.e. by means of corresponding computer programs, alternatively in hardware, i.e. by means of special electric circuits or devices, or in hybrid form, i.e. partially in software and partially in hardware.

The communication session server unit can comprise a conference session server unit, which provides a communication conference session, for example a half-duplex communication session or a conference session between several communication terminals. Within this description, a half-duplex communication session is to be understood, for example, as a communication session, in which a communication terminal or several communication terminals get assigned a communication right, for example temporarily, the communication right entitling them to provide data in the conference. The communication terminals, which are not provided with the communication right within the communication session, can at this time only receive the data introduced and can themselves not introduce any data in the communication session. For the example of a speech communication session this means that only one participant of a communication terminal or, where appropriate, one or more other communication terminals (where appropriate, usually only the host of the conference), get assigned the speech right, so that only one participant at a time can speak within the communication session, and the other participants are only able to receive the generated voice messages and are themselves not able to provide any voice messages in the communication session.

Thus the half-duplex communication session can be, for example, a push-to-talk communication session between several communication terminals, for example a communication session in accordance with “Direct Connect” of the company Nextel or a push-to-talk over cellular communication session, as it is standardized, for example in accordance with the Open Mobile Alliance.

Is has to be pointed out that the respective units provided for the realization of the communication session are configured and adapted according to which type of communication session is provided.

Furthermore, it has to be pointed out that the communication session can also be a communication session in accordance with the Conferencing Framework of the IETF (Internet Engineering Task Force).

For the example case of a push-to-talk over cellular communication session, this means that the central communication session server unit is a PoC controlling server unit and the data distribution unit comprises a direct communication connection with the communication terminals or a respective communication connection with the PoC participating units, assigned to the communication terminals, and via these with the communication terminals.

The first communication network and/or the second communication network can be configured as (a) mobile radio communication network(s).

In accordance with another embodiment it is provided that the first communication network and/or the second communication network are/is configured as (a) cellular communication network(s). The first communication network can be configured in accordance with a different communication standard than the second communication network.

Furthermore the first communication network itself, for the case that both (in general, several or all) communication networks are configured in accordance with the same standard, can be a communication network operated by a first network operator and the second communication network can be a communication network operated by a second network operator, which is usually a different network operator than the first network operator. In this case, it is provided, for example, that the communication is effected in a first communication network in a first specified frequency range (which is reserved for the first network operator) and that the communication in the second communication network, which is operated by another network operator, provides a communication in a second frequency range (which is reserved for the second network operator) which is different with respect to the first frequency range.

The first communication network and/or the second communication network can be configured based on a packet-oriented communication network, for example on an Internet-based communication network, in this case for example based on the Internet-based Multimedia Subsystem (IMS), which is provided within UMTS, and/or based on the so-called Mobile Media Distribution (MMD) communication protocol, which is provided within CDMA2000 and/or 3GGP2, for the provision of packet-switched communication services.

Illustratively it is achieved according to one embodiment of the invention that media in a conference system or in a push-to-talk system, respectively, in general within a communication session between a plurality of communication terminals, can be transmitted extremely simply between different communication networks. In other words, according to one embodiment of the invention in communication systems with a plurality of participants and with a plurality communication terminals, respectively, and a central server unit, a function is used per operator communication network, for the distribution of media (user data) and the distribution functions or the units providing the distribution functions, respectively, are generated and initiated, respectively, only in the case where they are required.

Furthermore a data distribution unit generation unit can be provided in the communication system for generating the data distribution unit. The data distribution unit generation unit can be configured for the generation of the data distribution unit when, within the communication session, data are to be transmitted to the at least one second data communication terminal and so far no data distribution unit exists in, or is available in, the second communication network. In other words, this means that the data distribution unit is generated only when and for example only if it is actually required. For example, the data distribution unit is generated in case of a requested data transfer to the at least one second communication terminal if, at the time of the data transfer request, no data distribution unit yet exists in the second communication network or no data distribution unit is available in the second communication network.

In accordance with another embodiment of the invention, a plurality of second communication terminals are provided in the second communication network. In this case, the data distribution unit can be configured in such a way that it receives data to be transmitted within the communication session from a first second communication terminal and forwards this data to a second second communication terminal. In other words, in this case the data to be transmitted are not transmitted directly from a first second communication terminal to the other second communication terminals, for example to a second second communication terminal, but from the first second communication terminal to the data distribution unit and from there the data to be transmitted are forwarded to the other second communication terminals, as well as further from the data distribution unit to the central communication session server unit in the first communication network.

In accordance with another embodiment of the invention it is provided, for the case of several second communication terminals in the second communication network, that the central communication session server unit is configured in such a way that it receives data to be transmitted within the communication session, from a first second communication terminal, and forwards this data to the data distribution unit. In other words, in this case the data to be transmitted are transmitted from a first second communication terminal to the central communication session server unit and forwarded from there to the data distribution unit in the second communication network. The data distribution unit, for its part, forwards the data to the other second communication terminals in the second communication network. Furthermore, the central communication session server unit sends the data to the at least one first communication terminal.

If the participants of the communication system and the communication terminals of the communication system, respectively, communicate with each other over different communication networks, then in those communication networks in which the central server unit of the communication system that provides the communication session is not located, functions are provided for the distribution of the media data. The distribution functions and the unit(s) providing these functions, respectively, distribute(s) the media data in their/its respective communication network. The distribution functions and the units providing these functions, respectively, receive media data from the central communication system server and the server unit, which provides the communication session, respectively. The units realizing the distribution functions, for example the data distribution unit, forward the received media data to the participants and the communication terminals, respectively, which are located in their communication network.

If a participant and a communication terminal, respectively, of a participant, respectively, sends media data from one of the communication networks to the other participants and the other communication terminals, respectively, then his data are sent to the central server unit, for example, to the communication session server unit, and are forwarded by this to the distribution functions and to the units realizing these functions, respectively. The distribution functions and the units realizing the functions, respectively, distribute the data in each case to the participants and to the communication terminals, respectively, in their communication network.

An advantage of this embodiment of the invention can be seen in that media data are transmitted not multiple times, but only once from the communication network, in which the central communication session server unit is located, to the communication terminals located in other communication networks and participating in the communication session. In this way, the quantity of data between the communication networks is decreased. This reduces possible transmission delays between the communication networks and relieves the load on the inter-communication network communication to the benefit of other communication services.

A further advantage can be seen in that only very few changes to the previous communication systems are necessary. Thus, for example, the participant communication terminals, as well as the participating functions, i.e. for example the PoC participating server units of push-to-talk over cellular communication systems in accordance with OMA, do not have to be changed.

Exemplary embodiments of the invention are shown in the figures and are explained in the following text in more detail. In the following figures, as far as appropriate, similar or equal elements are provided with identical reference signs.

In the following text a push-to-talk over cellular communication system is explained in more detail as an exemplary embodiment of the invention. It has to be pointed out, however, that any type of communication system can be employed in an alternative embodiment of the invention, in which a central server unit is provided, for example in an arbitrary other conference system, for example in a half-duplex communication system.

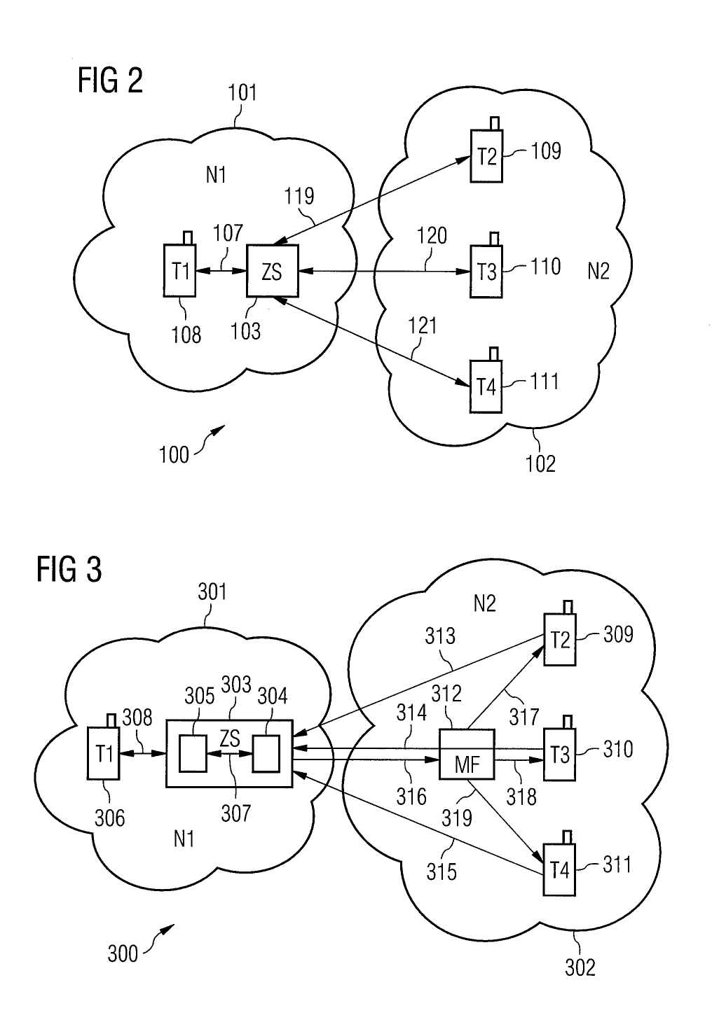

For a better understanding of the embodiment of the invention described in the following text, initially, with reference to FIG. 2, the architecture of the push-to-talk over cellular communication system 100 described in FIG. 1 is explained once again in simplified representation.

The push-to-talk over cellular communication system 100, as well as the communication system in accordance with the following embodiments of the invention, is a push-to-talk over cellular communication system in accordance with the OMA communications standard.

In FIG. 2, compared with FIG. 1, it is represented in simplified form that the four mobile communication terminals 108, 109, 110 and 111 communicate with each other not directly, but over a central server unit 103 by means of the respective communication connections 107, 119, 120 and 121.

FIG. 3 shows a push-to-talk over cellular communication system 300 in accordance with an embodiment of the invention, wherein the respective units are additionally configured in such a way that the components and their functionalities described in the following are realized.

The push-to-talk over cellular communication system 300 comprises a first communication network 301 operated by a first network operator, as well as a second communication network 302 operated by a second network operator.

As is shown in FIG. 3, a push-to-talk over cellular server unit (PoC server unit) 303 is provided in the first communication network 301, the PoC server unit 303 comprising a PoC controlling server unit 304, which is configured for the provision and control of a PoC communication session between several communication terminals and their participants, respectively. Furthermore, a first PoC participating server unit 305 is provided in the PoC server unit 303, the first PoC participating server unit 305 being assigned to a first mobile radio communication terminal 306. The PoC controlling server unit 304 and the first PoC participating server unit 305 are connected with each other via a first communication connection 307. The first PoC participating server unit 305 is connected with the first mobile radio communication terminal 306 by means of a first radio communication connection 308.

Each mobile communication terminal comprises at least one PoC client. A mobile communication terminal can be configured as a mobile radio telephone or any other arbitrary mobile radio communication terminal, for example integrated in a notebook, alternatively in a Personal Digital Assistant (PDA), a personal computer, etc.

It has to be pointed out that all communication connections described in the following are usually developed as bi-directional communication connections.

The first mobile radio communication terminal 306 is registered in the first communication network 301 which is configured in accordance with UTMS, and is in contact with the PoC controlling server unit 304, by means of the first radio communication connection 308 and the first PoC participating server unit 305, within the communication session generated by the first mobile radio communication terminal 306.

Thus it is assumed that the first participant T1 of the first mobile communication terminal 306 generates the communication session described in the following.

According to this embodiment of the invention, a communication session should be generated with three other participants, wherein the other mobile radio communication terminals are located in the second communication network 302, i.e. they are registered there.

As is shown in FIG. 3, a second mobile radio communication terminal 309 of a second participant T2, a third mobile radio communication terminal 310 of a third participant T3, as well as a fourth mobile radio communication terminal 311 of a fourth participant T4, are thus registered in the second communication network 302.

In this context it has to be pointed out that, in accordance with PoC, generally in accordance with a push-to-talk communication service, in each case the controlling server unit, i.e. the server unit, which provides and controls the communication session to be generated, is arranged in the same communication network in which is registered the mobile communication terminal generating the conference or the communication session.

However, alternatively it can be provided that the communication session server unit is arranged in another communication network.

In the following it is assumed that the first participant T1, and thus the first mobile radio communication terminal 306, sends an audio message (designated also as a voice message in the following) to the remaining participants and thus to the further mobile radio communication terminals 309, 310 and 311 in the second communication network 302.

The audio data transmitted in the voice message (usually speech data) are initially received by the central PoC server unit 303, there in particular by the PoC controlling server unit 304, and then transmitted by this to the other participants and their mobile communication terminals, respectively, wherein this is effected, in accordance with these embodiments of the invention, in such a way that the voice message(s) is/are not transmitted, as conventionally (compare FIG. 2), directly to the respective mobile communication terminal 109, 110 and 111 and to their participating server unit, respectively, but that only a one-time transmission of media data, according to this example of the invention of audio data, is effected between units of the two different communication networks 301, 302, i.e. across the communication network boundaries.

This is made possible in accordance with these embodiments of the invention by means of a data distribution unit 312 which is provided in the second communication network 302 (also designated in the following as media distribution unit or media distribution function). Thus it is provided, in accordance with these embodiments of the invention, that the PoC controlling server unit 304 no longer sends the audio data directly to each mobile radio communication terminal 109, 110 and 111, but only to the central data distribution unit 312 in the second communication network 302 (in case of several other communication networks, to the respective data distribution unit of the respective further communication network).

The central data distribution unit 312 receives the audio message(s) from the PoC controlling server unit 304 and subsequently routes the data, i.e. the audio message(s) to the participants, and their mobile radio communication terminals 309, 310 and 311, respectively, wherein this can be effected directly, or alternatively, for example when using push-to-talk over cellular, by means of the PoC participating server unit (not shown in FIG. 3) switched between the data distribution unit 312 and a respective mobile radio communication terminal 309, 310, 311. In this way, in accordance with these embodiments of the invention, the media data need to be transmitted only once instead of three times (as conventionally) from the PoC controlling server unit 304, in general from the central server unit 303 of the first communication network 301 to the other communication network 302.

If audio data should be distributed from a participant which is not associated with the first communication network 301 with the central PoC server unit 303, then the data will initially be transmitted from the participant and the respectively associated mobile radio communication terminal 309, 310 and 311, directly to the central push-to-talk over cellular server unit 303 and not by means of the media distribution function and the data distribution unit 312, respectively, which is represented in FIG. 3 by means of three direct communication connections 313, 314 and 315, which are provided between the respective mobile radio communication terminals 309, 310 and 311, and the central PoC server unit 303, where it is to be pointed out that, in accordance with an embodiment, the communication is effected using a PoC participating server unit connected between the mobile radio communication terminals 309, 310 and 311 and the PoC server unit 303, which is respectively assigned to a mobile radio communication terminal 309, 310, 311.

In this case the PoC server unit 303 sends, as shown above, the data to the data distribution unit 312 by means of the communication connection 316 between the PoC controlling server unit 304 and the data distribution unit 312, and the data distribution unit 312 transmits the data by means of corresponding messages, for example audio messages, alternatively messages containing other media data, for example video data, fixed-image data or textual data, to the respective mobile radio communication terminal 309, 310 and 311, by means of corresponding radio communication connections 317, 318 and 319.

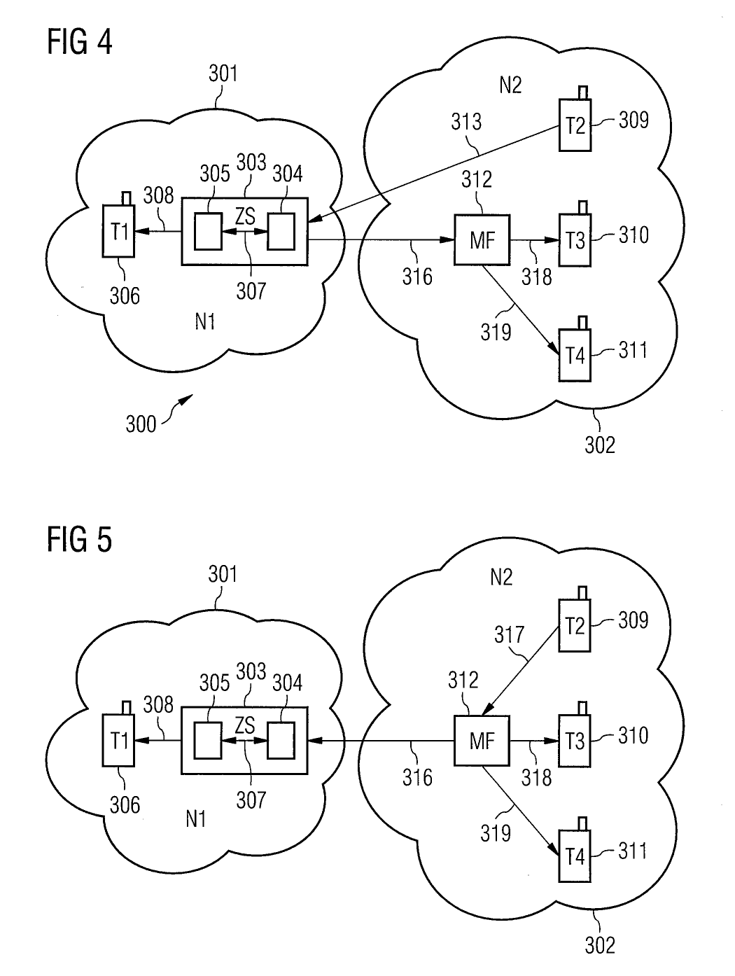

FIG. 4 shows the message flow and the distribution of the media data, respectively, in simplified representation, where it is assumed that an audio message from the second mobile radio communication terminal 309 is introduced in the communication session and this is transmitted to the central PoC server unit 303 by means of the communication connection 313 and therewith to the PoC controlling server unit 304 in particular. The received data are thus sent from the PoC controlling server unit 304 to the first mobile radio communication terminal in the first communication network 301, by means of the first radio communication connection 308. Furthermore, the data transmitted from the second mobile radio communication terminal 309 and received by the PoC controlling server unit 304 are transmitted to the third mobile radio communication terminal 310 and to the fourth mobile radio communication terminal 311, by transmitting the data, by means of the communication connection 316, to the data distribution unit 312 in the second communication network 302.

The data distribution unit 312 for its part sends the received data via the communication connection 318 to the third mobile radio communication terminal 310 and, by means of the fourth radio communication connection 319, to the fourth mobile radio communication terminal 311, respectively.

In this context, it has to be pointed out that the data distribution unit 312 is preferably generated only if it is required.

This happens for example in the following way:

First of all, the case of the setup of a push-to-talk over cellular communication session is considered.

In this connection, the case is discussed first of all where the PoC controlling server unit is located in the first communication network 301, and with that in the network of the inviting entity, i.e. the first mobile radio communication terminal 306, which generates the communication session and issues an invitation to this, respectively.

If an invited participant, i.e. a mobile communication terminal 309, 310 and 311 invited to the communication session, is associated with another communication network, in other words, if such a mobile radio communication terminal 309, 310 and 311 is registered in another communication network, then a data distribution unit (media distribution function) is generated in this communication network in the following way:

The second communication network 302, i.e. in other words the communication network of the invited mobile radio communication terminal, receives the invitation message. The communication network, and a corresponding unit provided in the communication network, respectively, checks whether the invitation message originates from another communication network and/or was sent from there. If this is the case, the unit checks within the second communication network whether a data distribution unit has already been generated for the push-to-talk over cellular communication session to which the invitation is issued by means of the invitation message. If this is not the case, the data distribution unit 312 is initialized, or in other words, generated. However, if the data distribution unit 312 has already been generated, the already existing data distribution unit 312 is then also employed within this communication session.

The second communication network 302, in other words the communication network of the invited mobile communication terminal, i.e. the communication network, which does not comprise the PoC controlling server unit, negotiates the addresses of the media transmission with the PoC controlling server unit 304 so that the media data are sent from the PoC controlling server unit 304 (controlling function) to the participant and to his mobile radio communication terminal, respectively, to the data distribution unit 312, in other words the media distribution function, of the second communication network 302, and the media data are sent from the participant and his mobile radio communication terminal, respectively, to the PoC controlling server unit 304 directly to the PoC controlling server unit 304, i.e. not by means of the data distribution unit 312.

The address negotiations are negotiated only for the first participant, that is for the first invited mobile radio communication terminal of an external network, in accordance with this embodiment of the invention, of the second communication network 302, as described above. For all further participants and their mobile radio communication terminals, respectively, only the media transmission of the participant and his mobile radio communication terminal, respectively, to the PoC controlling server unit 304 is negotiated as described above, that is in such a way, that the media are transmitted directly to the PoC controlling server unit 304 from the participant and his mobile radio communication terminal, respectively. For the transmission of data in the opposite direction it is negotiated that no media are transmitted by the PoC controlling server unit (controlling function) 304 to the participant and his mobile radio communication terminal, respectively. In this way it is ensured that the PoC controlling server unit 304 sends only once to the data distribution unit (media distribution function).

In every case where a new participant and his mobile radio communication terminal, respectively, of a communication network without controlling function is added, i.e., without a PoC controlling server unit in the communication network of the respective communication session, the address of the participant and of its mobile communication terminal, respectively, is recorded in a list of the data distribution unit 312 of the participant network (in this case of the second communication network 302). The data distribution unit 312 distributes media data which are sent from the PoC controlling server unit 304, to all participants and their mobile radio communication terminals, respectively, which are stored in the list of the data distribution unit 312.

Each communication network without PoC controlling server unit negotiates the addresses of the media transmission with the participants and their mobile radio communication terminals, respectively, which are associated with this communication network, in such a way that the media are sent from the participants and their mobile radio communication terminals, respectively, directly to the controlling function, i.e. to the PoC controlling server unit 304, and the media are transmitted from the data distribution functional unit 312 to the participants and to their mobile radio communication terminals, respectively.

The address negotiations can be carried out, for example, using corresponding protocol messages, for example in accordance with the communication protocol Session Initiation Protocol (SIP)/Session Description Protocol (SDP).

In the following the case is considered where the PoC controlling server unit 304 of the respective push-to-talk over cellular communication session is not located in the communication network of the mobile radio communication terminal inviting to the communication session.

Initially, the communication network of the inviting mobile radio communication terminal receives the invitation message, in order to transmit it to the communication network with the destination address. The communication network of the inviting mobile radio communication terminal checks whether the destination address is present in another communication network. If this is the case, the communication network or a correspondingly provided unit of the inviting mobile radio communication terminal located in the communication network, generates a media distribution function, in other words a corresponding data distribution unit, for the push-to-talk over cellular communication session, to which is invited.

The address negotiations are carried out as described above.

In the following, the generating of the data distribution unit is described for the case where a new participant and his mobile radio communication terminal, respectively, would like to join an existing PoC communication session.

In this case the communication network of the participant and of the mobile radio communication terminal, respectively, that would like to join an already existing PoC communication session, tests the controlling function, in other words the PoC controlling server unit 304 of the PoC communication session, in which the participant and the mobile communication terminal, respectively, would like to participate, as to whether it is located in a foreign i.e. other communication network. If this is the case, then the communication network, r a unit correspondingly provided in that, test whether it has already generated a data distribution unit 312 for the PoC communication session. If this is not the case, the communication network generates a corresponding data distribution unit 312. However, if a data distribution unit 312 already exists for the PoC communication session, then the existing data distribution unit is employed. The media address negotiations are effected as during the setup of a PoC communication session.

If the PoC controlling server unit 304 of the PoC communication session is located in the communication network of the participant and the communication terminal, respectively, which would like to join the existing communication session, no data distribution unit is generated or used, but a communication connection is built up directly with the PoC controlling server unit of the PoC communication session.

If the so-called IP Multimedia Subsystem (IMS) is used as a transport network, then the procedures for the generation of the data distribution unit 312 can be realized using so-called “IMS Filter Criteria”.

In the above-described embodiments it is illustrated that the media data of a participant and a participating mobile radio communication terminal, respectively, also in the case where the participant and the mobile radio communication terminal, respectively, are located in a different communication network than the PoC controlling server unit 304, are sent directly from the participant and his mobile radio communication terminal, respectively, (where appropriate, over the PoC participating server unit assigned to this participant in each case) to the controlling function, in other words, to the PoC controlling server unit 304. Alternatively it is provided that the media data are sent from a participant, which is located in a different communication network than the PoC controlling server unit 304, to the PoC controlling server unit 304, by means of the data distribution unit in the communication network of the participant. This has the advantage that the media data then no longer have to be forwarded to the data distribution unit 312 by the PoC controlling server unit 304.

FIG. 5 shows the alternative type of the distribution of the media from the second participant T2 of the second mobile radio communication terminal 309 in accordance with the example shown in FIG. 4, wherein the data, transmitted to the data distribution unit 312, are sent directly to the mobile radio communication terminals 310, 311 located in the same communication network 302, namely by means of the third radio communication connection 318 to the third mobile communication terminal 310 and, by means of the fourth radio communication connection 319, to the fourth mobile communication terminal 311.

As is shown in FIG. 5, the second mobile radio communication terminal 309 transmits the data to be transmitted by means of the second radio communication connection 317 to the data distribution unit 312, which, for its part, transmits this data to the mobile radio communication terminals 310, 311 in the second communication network 302. Furthermore, the data distribution unit 312 sends the data transmitted from the second mobile communication terminal 309, by means of the communication connection 316, to the central PoC server unit 303 and in particular to the PoC controlling server unit 304 located in that, which, for its part, forwards the data to the first PoC participating server unit 305 and via this to the first mobile radio communication terminal 306.

The data distribution unit 312 does not necessarily have to be a physically independent server, but can be realized by means of software. The software can run, for example, on a computer which unites all media distribution functions of a communication network for all communication sessions running there. Furthermore, the software can also be implemented on a computer, on which the push-to-talk server units of the respective communication network are realized.

Furthermore it has to be pointed out that the invention can also be employed in communication systems and in conference systems, respectively, which employ protocols other than those employed in the above description, in particular the protocols Initiation Session Protocol (SIP), Session Description Protocol (SDP), Binary Floor Control Protocol (BFCP), Real-time Transport Protocol (RTP) or Real-time Transport Control Protocol (RTCP). In particular, the address negotiations between the respective units do not have to be carried out with SIP/SDP messages.

Furthermore it has to be pointed out that, within the communication session, other types of data, instead of or in addition to audio data, can also be transmitted, for example any arbitrary media data, such as for example video data, freeze-image data or textual data.

1-41. (canceled)

42. A communication system, comprising:
a first communication network comprising a central communication session server unit configured to provide of a communication session between a plurality communication terminals;
at least one first communication terminal being registered in the first communication network;
a second communication network comprising a data distribution unit configured to distribute data to communication terminals,
at least one second communication terminal being registered in the second communication network;
the central communication session server unit configured to:
during setup of a communication session, establish, viavia the data distribution unit, a communication connection between the at least one first communication terminal and the at least one second communication terminal, and
send the data to be transmitted to the at least one second communication terminal within the communication session at least partially to the data distribution unit, or at least partially receive the data to be transmitted to the at least one first communication terminal within the communication session, from the data distribution unit and forward this data to the at least one first communication terminal,
the data distribution unit configured to receive the data to be transmitted to the at least one second communication terminal within the communication session and forward this data to the at least one second communication terminal or receive the data to be transmitted to the at least one first communication terminal within the communication session and forward this data to the central communication session server unit.

43. The communication system in accordance with claim 42, wherein the central communication session server unit comprises a conference session server unit.

44. The communication system in accordance with claim 42, wherein the central communication session server unit is configured to provide a half-duplex communication session between a plurality of communication terminals.

45. The communication system in accordance with claim 44, wherein the central communication session server unit is configured to provide a push-to-talk communication session between a plurality of communication terminals.

46. The communication system in accordance with claim 45, wherein the central communication session server unit is configured to provide a push-to-talk over cellular communication session between a plurality of communication terminals.

47. The communication system in accordance with claim 42, wherein the first communication network or the second communication network is a mobile radio communication network.

48. The communication system in accordance with claim 42, wherein the first communication network or the second communication network is a cellular communication network.

49. The communication system in accordance with claim 42, wherein the first communication network is configured in accordance with a different communication standard than the second communication network.

50. The communication system in accordance with claim 42, wherein the first communication network is a communication network operated by a first operator and the second communication network is a communication network operated by a second operator.

51. The communication system in accordance with claims 42, wherein the first communication network or the second communication network is configured based on a packet-oriented communication network.

52. The communication system in accordance with claim 51, wherein the first communication network or the second communication network is configured based on an Internet-based communication network.

53. The communication system in accordance with claim 52, wherein the first communication network or the second communication network is configured based on the Internet Protocol Multimedia Subsystem (IMS) or the Multimedia Domain (MMD).

54. The communication system in accordance with claim 42, further comprising a data distribution unit generation unit configured to generate the data distribution unit.

55. The communication system in accordance with claim 54, wherein the data distribution unit generation unit configured to generate the data distribution unit, if data is to be transmitted, within the communication session, to the at least one second data communication terminal and no data distribution unit had existed in the second communication network or no data distribution unit is available in the second communication network.

56. The communication system in accordance with claim 42, further comprising a plurality of second communication terminals,
wherein the data distribution unit is configured to receive the data to be transmitted within the communication session from a first second communication terminal and forward this data to at least one second communication terminal.

57. The communication system in accordance with claim 42, further comprising a plurality of second communication terminals,
wherein the central communication session server unit is configured to receive the data to be transmitted within the communication session from a first second communication terminal and forwards this data to the data distribution unit.

58. A communication session server unit in a first communication network for the provision of a communication session between a plurality of communication terminals, configured to:
establish, during setup of a communication session between at least one first communication terminal, registered in the first communication network, and at least one second communication terminal, registered in a second communication network, a communication connection with a data distribution unit arranged in the second communication network, and
send data to be transmitted, within the communication session data, to the at least one second communication terminal, at least partially to the data distribution unit, or receive data to be transmitted, within the communication session, to the at least one first communication terminal, at least partially from the data distribution unit and forward this data to the first communication terminal.

59. The communication session server unit in accordance with claim 58, wherein the communication session server unit comprises a conference session server unit.

60. The communication session server unit in accordance with claim 58, wherein the communication session server unit is configured to provide a half-duplex communication session between a plurality of communication terminals.

61. The communication session server unit in accordance with claim 60, wherein the communication session server unit is configured to provide a push-to-talk communication session between a plurality of communication terminals.

62. The communication session server unit in accordance with claim 61, wherein the communication session server unit is configured to provide a push-to-talk over cellular communication session between a plurality of communication terminals.

63. The communication session server unit in accordance with claim 58, wherein the first communication network or the second communication network is a mobile radio communication network.

64. The communication session server unit in accordance with claim 58, wherein the first communication network or the second communication network is a cellular communication network.

65. The communication session server unit in accordance with claim 58, wherein the first communication network is configured in accordance with a different communication standard than the second communication network.

66. The communication session server unit in accordance with claim 58, wherein the first communication network is a communication network operated by a first operator and the second communication network is a communication network operated by a second operator.

67. The communication session server unit in accordance with claim 58, wherein the first communication network or the second communication network is configured based on a packet-oriented communication network.

68. The communication session server unit in accordance with claim 67, wherein the first communication network or the second communication network is configured based on an Internet-based communication network.

69. The communication session server unit in accordance with claim 68, wherein the first communication network or the second communication network is configured based on the Internet Protocol Multimedia Subsystem (IMS) or the Multimedia Domain (MMD).

70. A data distribution unit in a second communication network for the distribution of data to communication terminals, configured to:
at least partially receive, within a communication session, provided by a communication session server unit located in a first communication network, between at least one first communication terminal registered in the first communication network and at least one second communication terminal registered in a second communication network, via a communication link established between the data distribution unit and the communication session server unit, data to be transmitted to the at least one second communication terminal within the communication session, and forward this data to the at least one second communication terminal, or
at least partially receive, within a communication session, provided by a communication session server unit located in a first communication network, between at least one first communication terminal registered in the first communication network and at least one second communication terminal registered in a second communication network, via a communication link established between the data distribution unit and the communication session server unit, data to be transmitted to the at least one first communication terminal, and forward this data to the communication session server unit.

71. The data distribution unit in accordance with claim 70, wherein the first communication network or the second communication network is a mobile radio communication network.

72. The data distribution unit in accordance with claim 70, wherein the first communication network or the second communication network is a cellular communication network.

73. The data distribution unit in accordance with claim 70, wherein the first communication network is configured in accordance with a different communication standard than the second communication network.

74. The data distribution unit in accordance with claim 70, wherein the first communication network is a communication network operated by a first operator and the second communication network is a communication network operated by a second operator.

75. The data distribution unit in accordance with claim 70, wherein the first communication network or the second communication network is configured based on a packet-oriented communication network.

76. The data distribution unit in accordance with claim 75, wherein the first communication network or the second communication network is configured based on an Internet-based communication network.

77. The data distribution unit in accordance with claim 76, wherein the first communication network or the second communication network is configured based on the Internet Protocol Multimedia Subsystem (IMS) or the MultiMedia Domain (MMD).

78. A method for transmitting data, within a communication session between at least one first communication terminal registered in a first communication network and at least one second communication terminal registered in a second communication network, comprising:
at least partially transmitting the data from a communication session server unit, located in the first communication network, for the provision of a communication session between a plurality of communication terminals, to a data distribution unit, located in the second communication network, for the distribution of data to communication terminals, or from the data distribution unit to the communication session server unit; and
forwarding the data from the data distribution unit to the at least one second communication terminal, or forwarding the data from the communication session server unit to the at least one first communication terminal.

79. A method for transmitting data, within a communication session between at least one first communication terminal registered in a first communication network and at least one second communication terminal registered in a second communication network, comprising:
at least partially receiving the data sent from a data distribution unit, located in the second communication network, for the distribution of data to communication terminals, by a communication session server unit, located in the first communication network, for the provision of a communication session between a plurality of communication terminals; and
forwarding the received data from the communication session server unit to the at least one first communication terminal.

80. A method for transmitting data, within a communication session between at least one first communication terminal registered in a first communication network and at least one second communication terminal registered in a second communication network, comprising:
at least partially receiving the data sent from the at least one first communication terminal by a communication session server unit, located in the first communication network, for the provision of a communication session between a plurality of communication terminals; and
forwarding the received data from the communication session server unit to a data distribution unit, located in the second communication network, for the distribution of data to communication terminals.

81. A method for transmitting data, within a communication session between at least one first communication terminal registered in a first communication network and at least one second communication terminal registered in a second communication network, comprising:
at least partially receiving the data sent from a communication session server unit located in the first communication network, for the provision of a communication session between a plurality of communication terminals, by a data distribution unit located in the second communication network, for the distribution of data to communication terminals; and
forwarding the received data by the data distribution unit to the at least one second communication terminal.

82. A method for transmitting data, within a communication session between at least one first communication terminal registered in a first communication network and at least one second communication terminal registered in a second communication network, comprising:
at least partially receiving the data sent from the at least one second communication terminal by a data distribution unit located in the second communication network, for the distribution of data to communication terminals; and
forwarding the received data by the data distribution unit to a communication session server unit located in the first communication network, for the provision of a communication session between a plurality of communication terminals.
